(19) United States
(12) Patent Application Publication
(10) Pub. No.: US 2006/0280375 A1
(43) Pub. Date: Dec. 14, 2006

(54) Red-eye correction method and apparatus with user-adjustable threshold

(76) Inventors: Dan L. Dalton, Greeley, CO (US); Christopher A. Whitman, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/148,680

(22) Filed: Jun. 8, 2005

(51) Int. Cl. G06K 9/40

(52) U.S. Cl. 382/275

(57) ABSTRACT

An electronic device that performs automatic red-eye correction on digital images includes a user-adjustable threshold, enabling the user to adjust the sensitivity of the automatic red-eye-correction algorithm dynamically while viewing marked candidate red-eye locations in a digital image. Such dynamic adjustment of the threshold facilitates the rejection of false positives while reducing the number of input gestures required of the user.

### FIELD OF THE INVENTION

The present invention relates generally to digital photography and more specifically to user interfaces used in conjunction with the correction of red-eye effect in digital images.

### BACKGROUND OF THE INVENTION

A pervasive problem in flash photography is the “red-eye effect,” in which an on-camera flash reflects off the back of the eyes of a subject, causing the eyes to appear red. The problem is so common that many digital photo-editing applications include automatic or manual red-eye correction. Some digital cameras are also capable of performing red-eye correction in the camera itself.

Automatic red-eye correction algorithms typically analyze the digital image based on a number of different features and assign a figure of merit to each potential red-eye region. The figure of merit may represent the degree of confidence that a particular potential red-eye region is indeed a “red eye.” Red-eye correction is then performed on the potential red-eye regions whose figures of merit exceed a predetermined threshold. The predetermined threshold is typically selected to exclude most false positives, but some false positives (e.g., a red button on a person's clothing) may nevertheless end up being corrected erroneously.

It is thus apparent that there is a need in the art for an improved red-eye correction method and apparatus.

### BRIEF DESCRIPTION OF THE DRAWINGS

FIG. 1A is a functional block diagram of an electronic device in accordance with an illustrative embodiment of the invention.

FIG. 1B is a high-level diagram of the memory of the electronic device shown in FIG. 1A in accordance with an illustrative embodiment of the invention.

FIG. 1C is an illustration of the display and input controls of the electronic device shown in FIG. 1A in accordance with an illustrative embodiment of the invention.

FIGS. 2A-2C are illustrations of a simplified digital image 205 on display 115 as it undergoes a series of red-eye-correction operations in accordance with an illustrative embodiment of the invention.

FIG. 3 is a flowchart of a method for correcting red-eye effect in a digital image in accordance with an illustrative embodiment of the invention.

FIGS. 4A-4C are illustrations of a simplified digital image 205 on display 115 as it undergoes a series of red-eye-correction operations in accordance with another illustrative embodiment of the invention.

FIG. 5 is a flowchart of a method for correcting red-eye effect in a digital image in accordance with another illustrative embodiment of the invention.

FIGS. 6A-6D are illustrations of a simplified digital image 205 on display 115 as it undergoes a series of red-eye-correction operations in accordance with yet another illustrative embodiment of the invention.

FIGS. 7A and 7B are a flowchart of a method for correcting red-eye effect in a digital image in accordance with yet another illustrative embodiment of the invention

### DETAILED DESCRIPTION OF THE INVENTION

Red-eye correction may be improved by allowing a user to adjust the threshold dynamically. After the digital image has been analyzed to identify candidate red-eye regions, the digital image may be presented to the user, and the candidate red-eye regions whose figures of merit exceed a predetermined initial threshold may be visibly marked within the digital image. As the user adjusts the threshold dynamically, more or fewer candidate red-eye regions may be visibly marked in accordance with the adjusted threshold.

One advantage of this approach is that the predetermined initial threshold may be set less sensitively at the outset to eliminate more false positives (candidate red-eye regions that do not contain a genuine “red eye”). If the algorithm misses genuine “red eyes,” the user may easily compensate by adjusting the threshold to increase the sensitivity. In some cases (i.e., where all false positives have less favorable figures of merit than all of the genuine “red eyes”), the user is not required to reject false positives individually (e.g., by navigating to a visibly marked candidate red-eye region and disqualifying it from subsequent red-eye correction). Instead, the user may eliminate all of the false positives by simply adjusting the threshold in the direction of reduced sensitivity. In cases where at least one false positive has a higher figure of merit than at least one genuine “red eye,” efficient user interface techniques, to be described more fully below, may be employed to reduce the number of actions required of the user to disqualify the false positives.

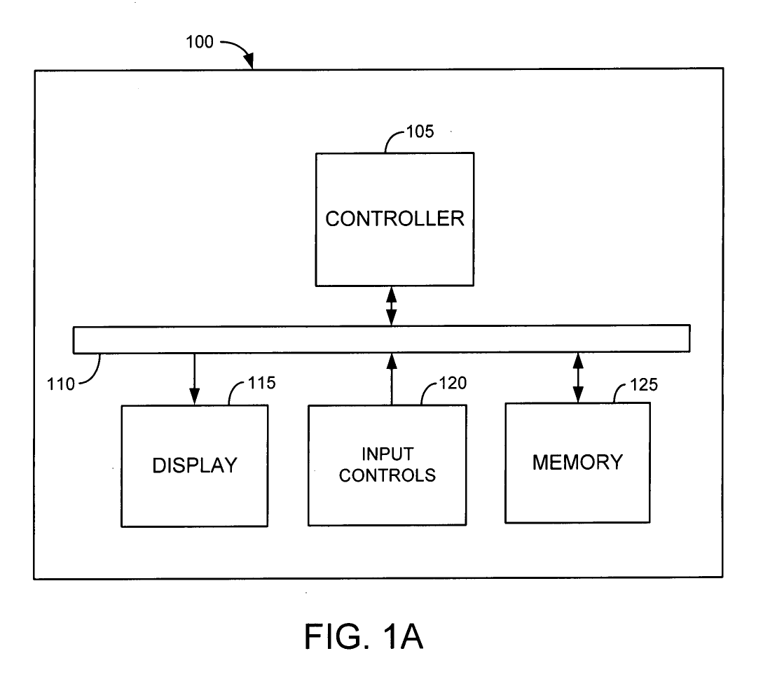

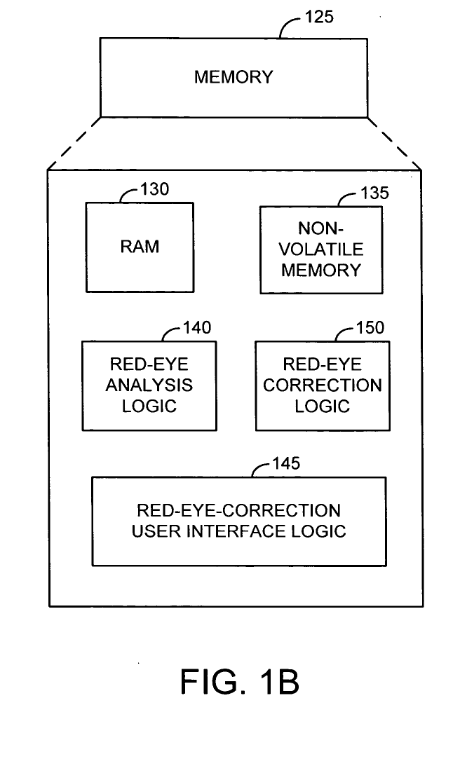

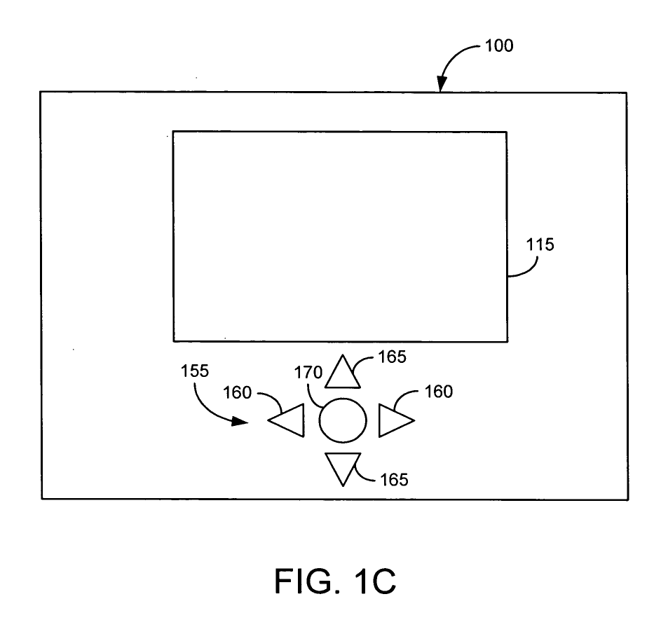

FIG. 1A is a functional block diagram of an electronic device 100 in accordance with an illustrative embodiment of the invention. Electronic device 100 may be, for example, a desktop computer, a notebook computer, a personal digital assistance (PDA), a digital camera, a radiotelephone (e.g., a cellular or PCS phone), or any other electronic device that is capable of storing and displaying a digital image and performing automatic red-eye correction on the digital image. In FIG. 1A, controller 105 communicates over data bus 110 with display 115, input controls 120, and memory 125. Controller 105 may comprise, for example, a microprocessor or microcontroller. Display 115 may comprise a liquid crystal display (LCD). In some embodiments, display 115 may comprise a touchscreen. Input controls 120 may include any input controls, physical or virtual, for controlling the operation of electronic device 100.

FIG. 1B is a high-level diagram of memory 125 of electronic device 100 in accordance with an illustrative embodiment of the invention. In general, memory 125 may comprise both random access memory (RAM) 130 and non-volatile memory 135, which may be of the removable variety (e.g., a secure digital or multi-media memory card). Memory 125 may further comprise red-eye analysis logic 140, red-eye-correction user interface logic 145, and red-eye correction logic 150.

Red-eye analysis logic 140 may identify one or more candidate red-eye regions in a digital image. Automatic red-eye correction techniques are well known in the digital image processing art. One example may be found in pending U.S. patent application Ser. No. 10/653,019, which is assigned to Hewlett-Packard Company, the disclosure of which is incorporated herein by reference. This reference describes, among other things, a design process in which a large number of features that could potentially help identify “red eyes” are applied to a database of digital images containing “red eyes,” and the features that most effectively distinguish “red eyes” are identified and employed in automatic red-eye correction within an electronic device such as a digital camera or personal computer.

Using techniques such as those discussed in the cited reference, red-eye analysis logic 140 may assign a figure of merit to each candidate red-eye region. The specifics of the figures of merit and the threshold against which they are compared may vary from one implementation to another. For example, depending on the implementation, the figure of merit may vary either directly or inversely with the degree of confidence that the associated candidate red-eye region is a genuine “red eye.” In the former case (direct variation), a “good” candidate red-eye region would have a figure of merit that exceeds the threshold; in the latter case (inverse variation), a “good” candidate red-eye region would have a figure of merit that falls below the threshold. To avoid confusion on this point, it will be assumed throughout this detailed description and in the claims that follow, without loss of generality, that a candidate red-eye region whose associated figure of merit “exceeds a threshold” qualifies for visible marking and presentation to the user on display 115, regardless of whether the figure of merit varies directly or inversely (or in some other fashion) with the degree of confidence. In this detailed description, “confidence score” will sometimes be used interchangeably with “figure of merit.”

Red-eye-correction user interface logic 145 may visibly mark on display 115 the candidate red-eye regions whose confidence scores exceed the threshold. Initially, red-eye-correction user interface logic 145 may do so based on a predetermined initial value of the threshold (e.g., one selected as a reasonable compromise, based on empirical results). As the user adjusts the threshold from its predetermined initial value, red-eye-correction user interface logic 145 may update the visibly marked candidate red-eye regions in accordance with the adjusted threshold. In some embodiments, each discrete adjustment of the threshold (e.g., button press or stylus tap) causes at least one additional or one fewer candidate red-eye region to be visibly marked, depending on the sense in which the threshold is adjusted. That is, red-eye-correction user interface logic 145 may quantize the discrete adjustment steps of the threshold such that they coincide with the figures of merit associated with the candidate red-eye regions in a particular digital image. Those skilled in the art will recognize that it may be advantageous to repeat certain red-eye-correction analysis steps such as duplicate removal, a skin tone test, and pair matching after each discrete adjustment of the threshold.

“Visibly marking” may be implemented in a variety of ways that are well known in the user interface art. For example, the candidate red-eye regions whose confidence scores exceed the threshold may be enclosed in a geometric figure (e.g., a bounding box, circle, or other shape). A particular color may be chosen for the enclosing geometric figure that helps the visibly marked candidate red-eye regions to stand out from the rest of the digital image.

Red-eye correction logic 150 may perform red-eye correction in each visibly marked candidate red-eye region after the user has, if necessary, adjusted the threshold or otherwise disqualified (eliminated from red-eye correction) one or more false positives. Though more details are provided in the above-cited reference, red-eye correction essentially involves replacing the red pixels of “red eyes” with those of a more suitable color.

Red-eye analysis logic 140, red-eye-correction user interface logic 145, and red-eye correction logic 150 may be implemented as software, firmware, hardware, or any combination thereof. In one embodiment, red-eye analysis logic 140, red-eye-correction user interface logic 145, and red-eye correction logic 150 may be stored program instructions residing in firmware that are executed by controller 105. The functional boundaries among red-eye analysis logic 140, red-eye-correction user interface logic 145, and red-eye correction logic 150 indicated in FIG. 1B are, furthermore, arbitrary. The functionality of these elements may be combined or separated in many other possible ways, and those variations are all considered to be within the scope of the invention as claimed.

FIG. 1C is an illustration of display 115 and some of the input controls 120 of electronic device 100 in accordance with an illustrative embodiment of the invention. In FIG. 1C, it has been assumed for illustrative purposes that electronic device 100 is a digital camera (the back side of which is shown in FIG. 1C). In other embodiments in which electronic device 100 is of a different type or in which a different kind of user interface is employed, the specifics of display 115 and input controls 120 may differ significantly. In FIG. 1C, input controls 120 may include a set of user interface controls 155 comprising two pairs of opposing directional controls, horizontal directional controls 160 and vertical directional controls 165, and menu/“ok” button 170. This set of user interface controls 155 may comprise physical buttons, as shown in FIG. 1C, or they may comprise virtual buttons on, e.g., a touch-sensitive screen (display 115). In the case of a touchscreen, a stylus held by the user may be used to touch particular control elements on display 115, eliminating the need for most physical buttons. The opposing directional controls (160 and 165) may be used, for example, to navigate among and give focus to items on display 115. These controls may also be used to toggle the status of particular options in electronic device 100 in a variety of contexts. Menu/“ok” button 170 may be used to call up a menu on display 115 or to confirm actions in electronic device 100 (much like an “enter” key on a computer keyboard). In embodiments in which electronic device 100 is a computing device such as a desktop or notebook computer, the set of user interface controls 155 may be, e.g., a mouse, trackball, or other pointing device, and a full-size keyboard may be available to the user.

Of the various input controls 120, three types of functional input controls are of particular utility in the context of the invention: (1) a threshold adjustment control, (2) a navigational control, and (3) a status control. A “threshold adjustment control” allows the user to adjust the threshold in either direction (more or less sensitive). A “navigational control” allows the user to navigate to and select (give focus to) a particular candidate red-eye region. A “status control” allows the user to disqualify a particular selected candidate red-eye region so that the disqualified candidate red-eye region will not be included in subsequent red-eye correction performed by red-eye correction logic 150. Such an input from the user will sometimes be referred to in this detailed description as a “rejection input.” In some embodiments, the status control may also be used to requalify a previously disqualified candidate red-eye region (e.g., the user changes his mind after disqualifying a visibly marked candidate red-eye region). Such an input from the user will sometimes be referred to in this detailed description as an “acceptance input.”

All three of the foregoing functional input controls may be implemented using any suitable user interface technology, including the illustrative examples mentioned above. For example, in one embodiment, the threshold adjustment control may be implemented using vertical directional controls 165. Pressing the “up” arrow, for example, may cause more candidate red-eye regions to be visibly marked, and pressing the “down” arrow may cause fewer candidate red-eye regions to be marked, or vice versa. To cite a further example, the status control may be implemented using horizontal directional controls 160. Pressing the “left” arrow, for example, may disqualify a particular selected candidate red-eye region, and pressing the “right” arrow may requalify that candidate red-eye region, undoing the disqualification, or vice versa. A navigational control may also be implemented using some or all of the opposing directional controls (160 and 165). However, all of the foregoing functional controls may also be implemented using a touchscreen and stylus, a mouse, trackball, or other user interface technology. In the case of a touchscreen, for example, the user may touch one or more virtual control elements to adjust the threshold, and a touch of the stylus may be used to navigate to or to disqualify/requalify individual candidate red-eye regions directly. The same is true of a mouse or other pointing device.

Three particular illustrative embodiments of the invention will now be described in succession using a series of illustrations and a method flowchart for each embodiment.

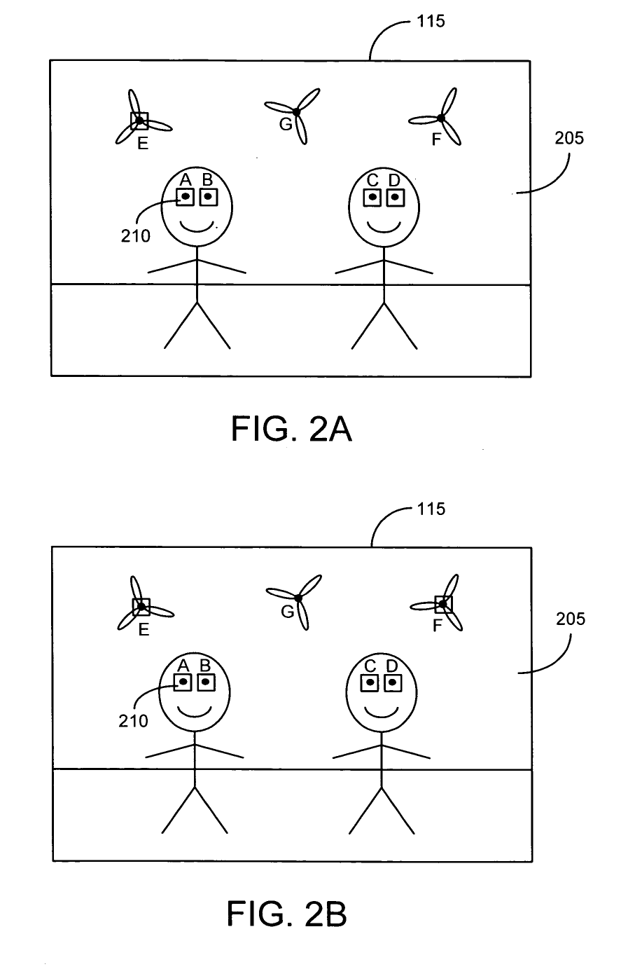

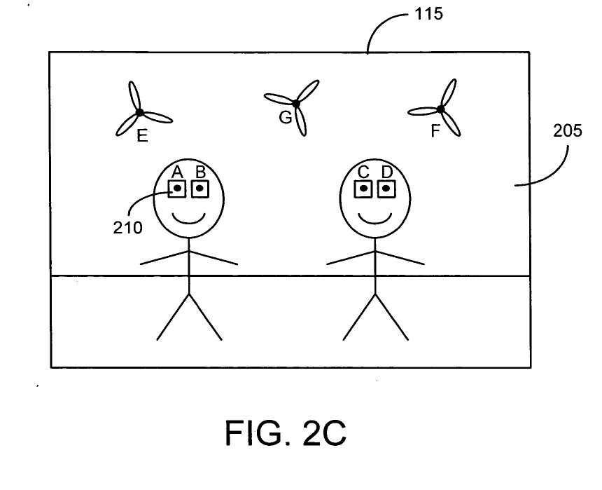

FIGS. 2A-2C are illustrations of a simplified digital image 205 on display 115 as it undergoes a series of red-eye-correction operations in accordance with an illustrative embodiment of the invention. In FIG. 2A, red-eye analysis logic 140 has identified a total of seven candidate red-eye regions 210, which have been individually identified for convenience in FIG. 2A using letters “A” through “G” in the order of their decreasing confidence (i.e., “A” is the candidate red-eye region 210 whose figure of merit is the most favorable, and “G” is the candidate red-eye region whose figure of merit is the least favorable). (To avoid cluttering the figure, only one candidate red-eye region 210 (“A”) has been annotated with a reference numeral.) In FIG. 2A, candidate red-eye regions 210 “A” through “E” have figures of merit that exceed the predetermined initial value of the threshold. Therefore, red-eye-correction user interface logic 145 has visibly marked only those candidate red-eye regions 210.

In FIG. 2B, a user has used a threshold adjustment control to include more candidate red-eye regions 210. Note that candidate red-eye region 210 “F” is now visibly marked. An additional adjustment of the threshold adjustment control in the same sense would cause “G” to become visibly marked as well.

In FIG. 2C, a user has used a threshold adjustment control to include fewer candidate red-eye regions 210. Relative to FIG. 2A, a single actuation of the threshold adjustment control in the appropriate sense causes the visible marking of false positive candidate red-eye region 210 “E” to disappear, leaving only valid candidate red-eye regions 210 “A” through “D.” At this point, the user may issue an input (e.g., pressing menu/“ok” button 170 or touching an appropriate control element with a stylus) to cause red-eye correction logic 150 to perform red-eye correction in each of the visibly marked candidate red-eye regions 210 (“A” through “D”).

In the example of FIGS. 2A-2C, the false positives (“E” through “G”) all have figures of merit that are less favorable than all of the valid candidate red-eye regions 210 (“A” through “D”). Though this is the ideal situation, it may not always occur in practice. In some situations, at least one of the false positives might have a figure of merit that is more favorable than that of at least one of the genuine “red eyes.” In such a case, the user may adjust the threshold to a compromise setting that minimizes the number of false positives but which still corrects all of the valid “red eyes.”

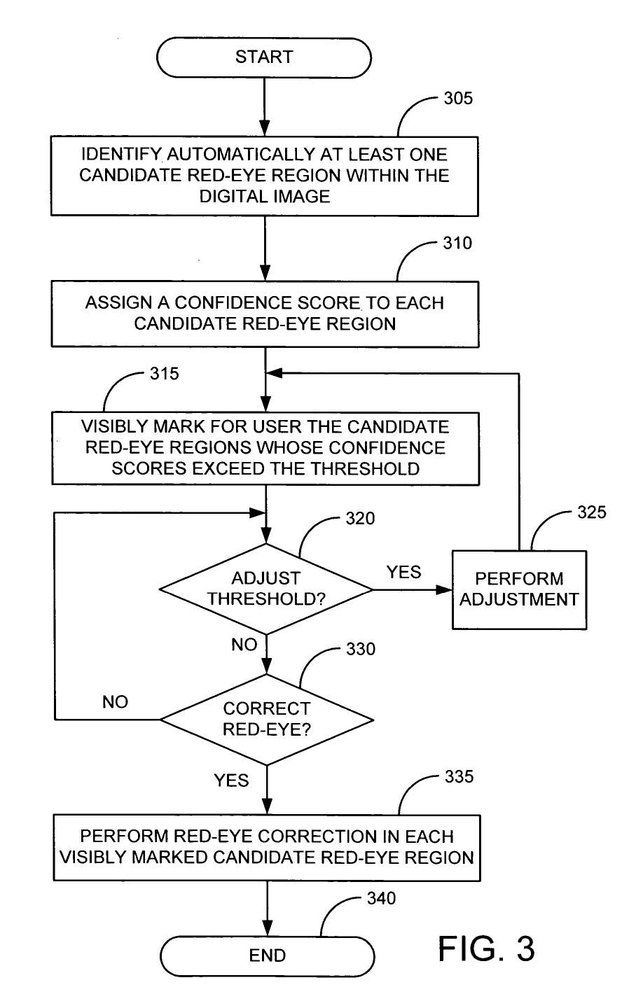

FIG. 3 is a flowchart of a method for correcting red-eye effect in a digital image in accordance with an illustrative embodiment of the invention. FIG. 3 corresponds to the example shown in FIGS. 2A-2C. At 305, red-eye analysis logic 140 may identify one or more candidate red-eye regions 210 within a digital image 205. Red-eye analysis logic 140 may assign to each candidate red-eye region 210 a confidence score (figure of merit) at 310. At 315, red-eye-correction user interface logic 145 may visibly mark the candidate red-eye regions 210 whose confidence scores exceed the initial (nominal) threshold. At steps 320 and 325, a user may adjust the threshold, and red-eye-correction user interface logic 145 may update the visibly marked candidate red-eye regions 210 in accordance with the adjusted threshold, as explained above. Once the user has finished adjusting the threshold, the process may proceed to step 330, where the user is presented with the option to perform red-eye correction on the visibly marked candidate red-eye regions 210 currently shown on display 115. At 335, red-eye correction logic 150 may perform red-eye correction on each visibly marked candidate red-eye region 210. At 340, the process may terminate.

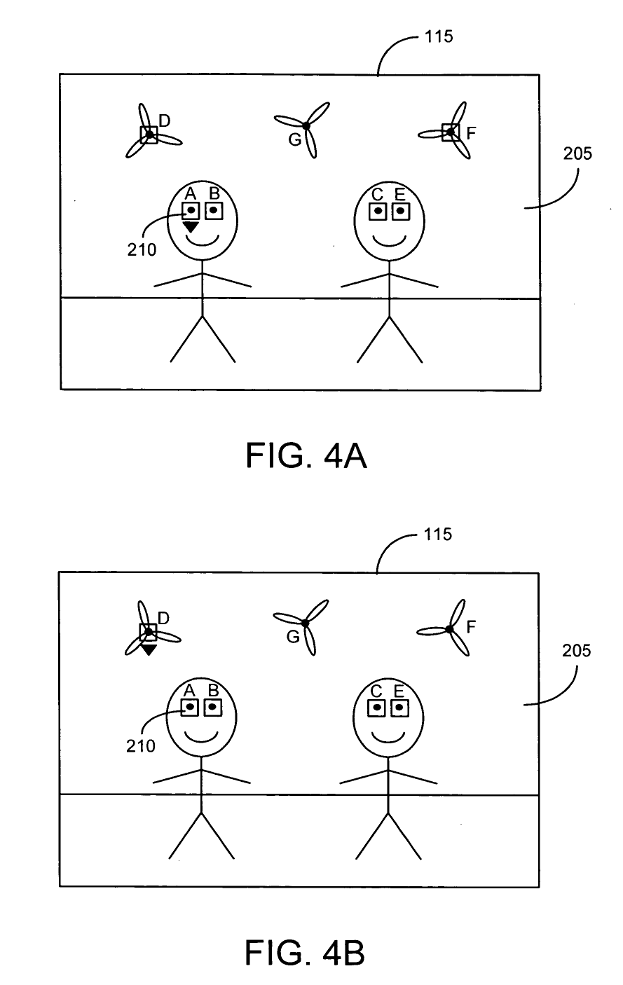

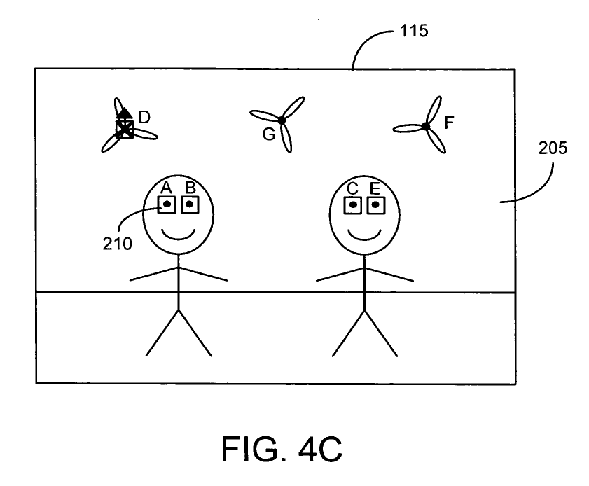

FIGS. 4A-4C are illustrations of a simplified digital image 205 on display 115 as it undergoes a series of red-eye-correction operations in accordance with another illustrative embodiment of the invention. In FIG. 4A, red-eye analysis logic 140 has identified seven total candidate red-eye regions 210, six of which (“A” through “F”) have confidence scores exceeding the predetermined initial threshold. Consequently, red-eye-correction user interface logic 145 has visibly marked candidate red-eye regions 210 “A” through “F.” As in FIGS. 2A-2C, successive letters “A” through “G,” in alphabetical order, correspond to decreasing confidence scores. In this particular embodiment, an arbitrary visibly marked candidate red-eye region 210 is automatically selected by default. In this illustrative example, the selected visibly marked candidate red-eye region 210 happens to be “A,” but it could be any other visibly marked candidate red-eye region 210 (e.g., “F,” which is the lowest-confidence visibly marked candidate red-eye region 210). Optionally, a triangular icon (“down” arrow) may be placed below the selected visibly marked candidate red-eye region 210, as shown in FIG. 4A, to indicate to the user that touching the “down” arrow icon with a stylus or pressing “down” arrow 165 (a rejection input) will disqualify the selected visibly marked candidate red-eye region 210. In general, a status control, as defined above, may be provided that allows the user to disqualify or requalify the currently selected visibly marked candidate red-eye region 210. The implementation of the status control suggested by FIG. 4A is merely one example.

In FIG. 4B, the user has adjusted the threshold to exclude false-positive candidate red-eye region 210 “F.” Note that although the user has succeeded in eliminating one false positive, false-positive candidate red-eye region 210 “D” remains visibly marked. Adjusting the threshold further in the direction of less sensitivity would have the undesired effect of disqualifying valid candidate red-eye region 210 “E.” The user, therefore, needs a means to disqualify false-positive candidate red-eye region 210 “D” without affecting “E.” This can be accomplished by providing the user with a navigational control, as explained above. Once the user has adjusted the threshold to the desired level, the user may then enter a separate mode, controlled by red-eye-correction user interface logic 145, in which it is possible to navigate freely among the remaining visibly marked candidate red-eye regions 210. In FIG. 4B, the user has used such a navigational control to navigate to and select visibly marked candidate red-eye region 210 “D.” With “D” selected, the user may use a status control to disqualify “D.” Regarding navigation among individual visibly marked candidate red-eye regions 210, additional details of a similar user interface are provided in pending U.S. patent application Ser. No. 10/767,355, which is assigned to Hewlett-Packard Company, the disclosure of which is incorporated herein by reference.

In FIG. 4C, the user has disqualified visibly marked candidate red-eye region 210 “D.” FIG. 4C shows one example of how red-eye-correction user interface logic 145 may visibly indicate that visibly marked candidate red-eye region 210 “D” has been disqualified. In FIG. 4C, visibly marked candidate red-eye region 210 “D” has been crossed through with an “X.” In other embodiments, the bounding box or other geometric figure enclosing visibly marked candidate red-eye region 210 “D” may be altered in some other way (e.g., it may change color or shape). Optionally, an “up” arrow icon may be placed above visibly marked candidate red-eye region 210 “D” to indicate to the user that touching the “up” arrow icon with a stylus or pressing “up” arrow button 165 (an acceptance input) will requalify visibly marked candidate red-eye region 210 “D.” Again, this is merely one possible way of implementing a status control, as defined above, in this context. With all the valid candidate red-eye regions 210 (“A” through “E”) visibly marked and false-positive visibly marked candidate red-eye region 210 “D” disqualified as shown in FIG. 4C, the user may proceed to issue a command to electronic device 100 that invokes red-eye correction logic 150, which performs red-eye correction in each visibly marked candidate red-eye region that has not been disqualified.

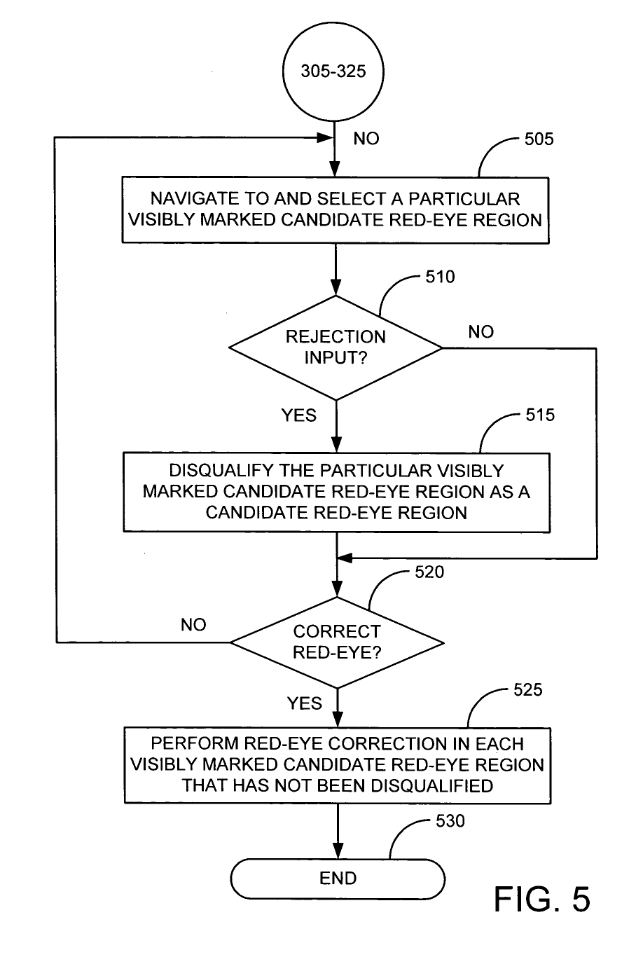

FIG. 5 is a flowchart of a method for correcting red-eye effect in a digital image in accordance with another illustrative embodiment of the invention. FIG. 5 corresponds to the example shown in FIGS. 4A-4C. After steps 305, 310, 315, 320, and 325 in FIG. 3 (those involving adjustment of the threshold) have been performed, red-eye-correction user interface logic 145 may, at 505, navigate to and select a particular visibly marked candidate red-eye region 210 in response to the user's actuation of a navigational control. If a rejection input is received from the user at 510, red-eye-correction user interface logic 145 may, at 515, disqualify the particular visibly marked candidate red-eye region 210. Once the user has finished navigating to and disqualifying false positives at 520, red-eye correction logic 150 may, at 525, perform red-eye correction on each visibly marked candidate red-eye region that has not been disqualified. At 530, the process may terminate.

Though not shown in FIG. 5 to promote clarity, at a step analogous to step 510, the user may also issue an acceptance input to requalify for subsequent red-eye correction at 525 a visibly marked candidate red-eye region 210 that has been previously disqualified (i.e., whenever a given visibly marked candidate red-eye region 210 is selected, the user may toggle the red-eye correction status of that visibly marked candidate red-eye region 210 using a suitable status control).

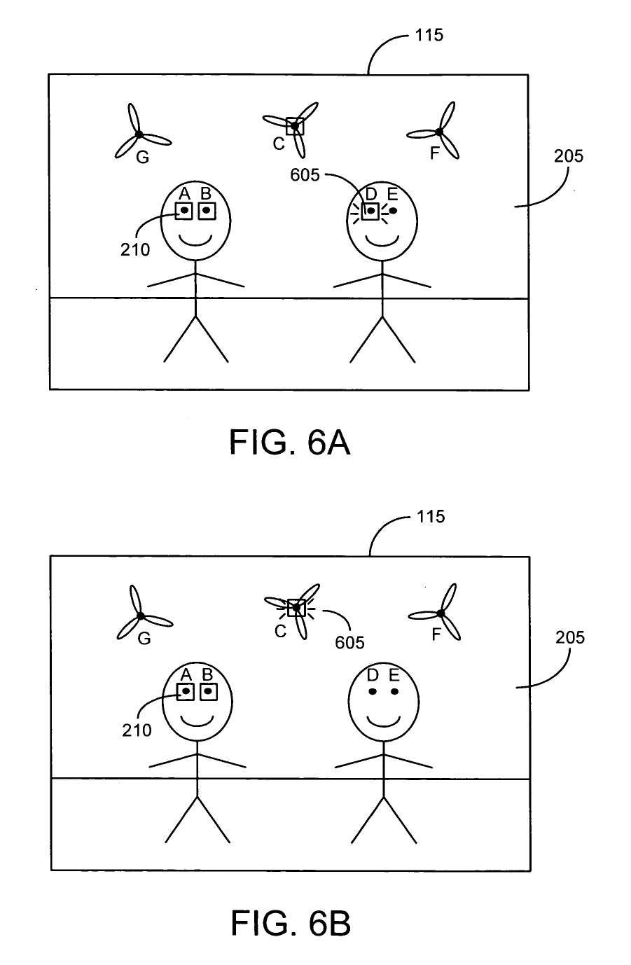

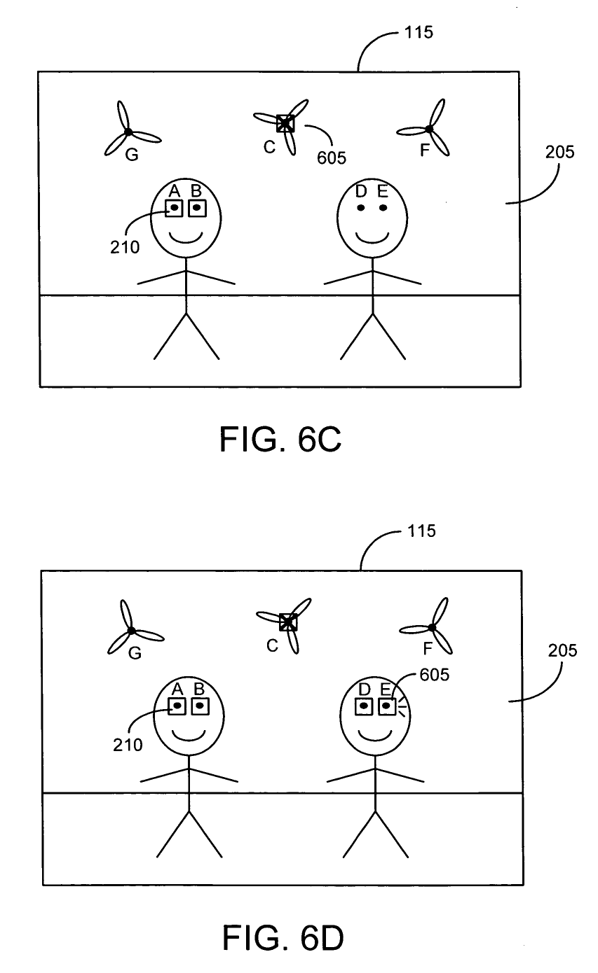

FIGS. 6A-6D illustrate an efficient user interface that combines navigation with disqualification/requalification of visibly marked candidate red-eye regions 210 in accordance with yet another illustrative embodiment of the invention. As in FIGS. 2A-2C, successive letters “A” through “G” correspond, in alphabetical order, to decreasing confidence scores. In FIG. 6A, the difficulty again occurs (see FIGS. 4A-4C) that one of the visibly marked candidate red-eye regions 210 (“C”) has a more favorable figure of merit than two of the valid candidate red-eye regions 210 (“D” and “E”). In this particular embodiment, red-eye-correction user interface logic 145 may visibly distinguish the visibly marked candidate red-eye region 210 having the lowest-confidence figure of merit (“lowest-confidence candidate red-eye region” 605) from the other visibly marked candidate red-eye regions 210. At the same time, red-eye-correction user interface logic 145 may also select the lowest-confidence candidate red-eye region 605 for optional disqualification or requalification in response to a rejection or acceptance input, respectively. “Visibly distinguished” may mean, for example, that the lowest-confidence candidate red-eye region 605's enclosing geometric figure blinks or is of a different color than that of the other visibly marked candidate red-eye regions 210. In general, any technique that visibly differentiates lowest-confidence candidate red-eye region 605 from all other visibly marked candidate red-eye regions 210 may be employed. In the example of FIGS. 6A-6D, red-eye-correction user interface logic 145 causes the bounding box surrounding the lowest-confidence candidate red-eye region 605 to blink. As the user adjusts the threshold using a threshold adjustment control, red-eye-correction user interface logic 145 updates and visibly distinguishes the lowest-confidence candidate red-eye region 605 accordingly. In FIG. 6A, lowest-confidence candidate red-eye region 605 is the visibly marked candidate red-eye region 210 labeled “D.” FIGS. 6B-6D show how, using few input commands, the false positives can be disqualified and the four valid “red eyes” (candidate red-eye regions 210 “A,” “B,” “D,” and “E”) can be corrected.

In FIG. 6B, the user has adjusted the threshold to exclude candidate red-eye region 210 “D.” This action causes the current lowest-confidence candidate red-eye region 605 to become “C” (shown as blinking in FIG. 6B).

In FIG. 6C, the user has used a status control to disqualify lowest-confidence candidate red-eye region 605 “C” (crossed through with an “X” in FIG. 6C).

In FIG. 6D, the user has adjusted the threshold in the direction of greater sensitivity by two increments to include candidate red-eye regions 210 “D” and “E,” the latter of which has now become lowest-confidence candidate red-eye region 605. At this point, the user may proceed to issue a command to electronic device 100 that invokes red-eye correction logic 150, which performs red-eye correction in each visibly marked candidate red-eye region 210 that has not been disqualified.

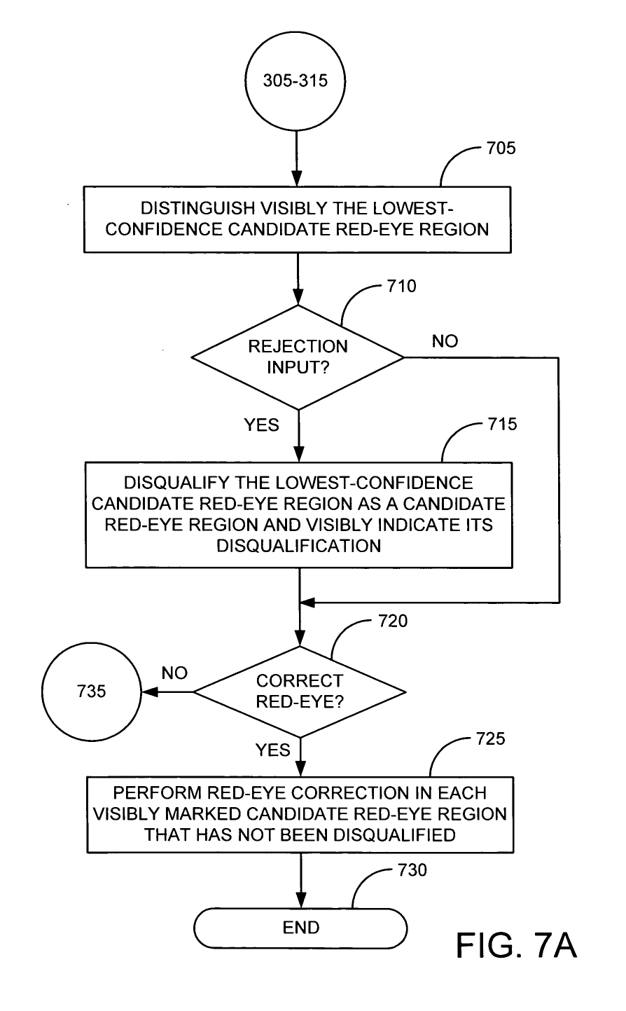

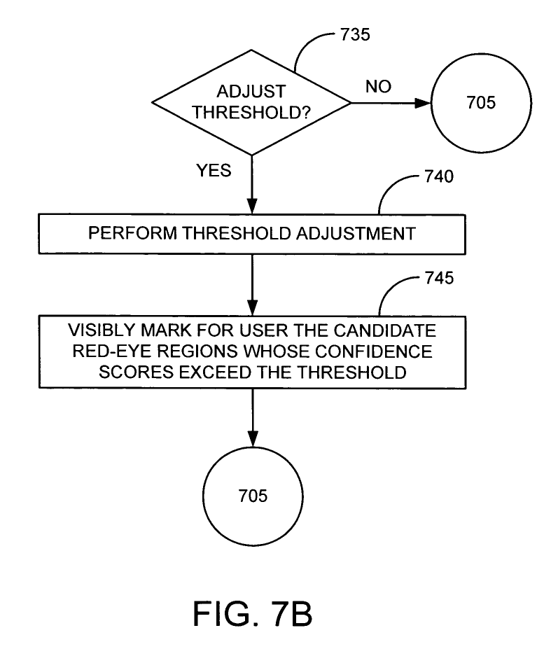

FIGS. 7A and 7B are a flowchart of a method for correcting red-eye effect in a digital image in accordance with yet another illustrative embodiment of the invention. FIGS. 7A and 7B correspond to the example shown in FIGS. 6A-6D. After steps 305, 310 and 315 in FIG. 3 have been performed, red-eye-correction user interface logic 145 may, at 705, visibly distinguish the lowest-confidence candidate red-eye region 605 from the other visibly marked candidate red-eye regions 210, as explained above. If a rejection input is received from the user at 710, red-eye-correction user interface logic 145 may, at 715, disqualify the lowest-confidence candidate red-eye region 605 from subsequent red-eye correction. If, at 720, the user is ready to perform red-eye correction, the user may input a suitable command to electronic device 100 to invoke red-eye correction logic 150, which performs red-eye correction in each visibly marked candidate red-eye region 210 that has not been disqualified. Following red-eye correction at 725, the process may terminate at 730. If, however, the user does not initiate red-eye correction at 720, the process proceeds to step 735, where the user has the option of making additional threshold adjustments before the process returns to step 705.

Though not shown in FIG. 7A to promote clarity, at a step analogous to step 710, the user may also issue an acceptance input to requalify for subsequent red-eye correction at 725 a visibly marked candidate red-eye region 210 that has been previously disqualified (i.e., red-eye-correction user interface logic 145 may toggle the red-eye correction status of the lowest-confidence candidate red-eye region 605 in response to a rejection or acceptance input from the user).

The foregoing description of the present invention has been presented for the purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for correcting red-eye effect in a digital image, comprising:
identifying automatically at least one candidate red-eye region within the digital image;
assigning a confidence score to each candidate red-eye region;
visibly marking for a user the candidate red-eye regions whose confidence scores exceed a threshold, the threshold having a predetermined initial value; and
adjusting the threshold dynamically in response to input from the user.

2. The method of claim 1, further comprising:
updating which candidate red-eye regions are visibly marked in accordance with the threshold as the threshold is dynamically adjusted.

3. The method of claim 2, wherein at least one additional candidate red-eye region is visibly marked, when the threshold is adjusted in a first sense, and at least one fewer candidate red-eye region is visibly marked, when the threshold is adjusted in a second sense opposite the first sense.

4. The method of claim 2, further comprising:
producing a modified digital image by performing red-eye correction in each visibly marked candidate red-eye region.

5. The method of claim 2, further comprising:
selecting and distinguishing visibly from the other visibly marked candidate red-eye regions a lowest-confidence candidate red-eye region, the lowest-confidence candidate red-eye region having a least favorable confidence score among the visibly marked candidate red-eye regions; and
disqualifying the lowest-confidence candidate red-eye region as a candidate red-eye region in response to a rejection input from the user.

6. The method of claim 5, further comprising:
visibly indicating that the lowest-confidence candidate red-eye region has been disqualified as a candidate red-eye region.

7. The method of claim 5, further comprising:
requalifying the lowest-confidence candidate red-eye region as a candidate red-eye region in response to an acceptance input from the user.

8. The method of claim 5, further comprising:
producing a modified digital image by performing red-eye correction in each visibly marked candidate red-eye region that has not been disqualified.

9. The method of claim 2, further comprising:
navigating to and selecting a particular visibly marked candidate red-eye region in response to a navigation input from the user; and
disqualifying the particular candidate red-eye region as a candidate red-eye region in response to a rejection input from the user.

10. The method of claim 9, further comprising:
producing a modified digital image by performing red-eye correction in each visibly marked candidate red-eye region that has not been disqualified.

11. The method of claim 1, wherein visibly marking for a user the candidate red-eye regions whose confidence scores exceed a threshold comprises enclosing each of those candidate red-eye regions within a geometric figure.

12. A method for correcting red-eye effect in a digital image, comprising:
identifying automatically at least one candidate red-eye region within the digital image;
assigning a figure of merit to each candidate red-eye region;
visibly marking for a user the candidate red-eye regions whose figures of merit exceed a threshold, the threshold having a predetermined initial value;
adjusting the threshold dynamically in response to input from the user; and
updating which candidate red-eye regions are visibly marked in accordance with the threshold as the threshold is dynamically adjusted.

13. The method of claim 12, further comprising:
performing red-eye correction in each of the visibly marked candidate red-eye regions.

14. The method of claim 12, further comprising:
selecting and distinguishing visibly from the other visibly marked candidate red-eye regions a lowest-confidence candidate red-eye region, the lowest-confidence candidate red-eye region having a least favorable figure of merit among the visibly marked candidate red-eye regions; and
disqualifying the lowest-confidence candidate red-eye region as a candidate red-eye region in response to a rejection input from the user.

15. The method of claim 14, further comprising:
requalifying the lowest-confidence candidate red-eye region as a candidate red-eye region in response to an acceptance input from the user.

16. The method of claim 14, further comprising:
performing red-eye correction in each visibly marked candidate red-eye region that has not been disqualified.

17. An electronic device, comprising:
a memory in which to store a digital image;
a display on which to show the digital image;
red-eye analysis logic to identify automatically at least one candidate red-eye region within the digital image, the red-eye analysis logic being configured to assign a figure of merit to each candidate red-eye region;
red-eye-correction user interface logic configured to mark visibly for a user on the display the candidate red-eye regions whose figures of merit exceed a threshold, the threshold having a predetermined initial value; and
a threshold adjustment control with which the user may adjust the threshold.

18. The electronic device of claim 17, wherein the threshold adjustment control comprises a pair of opposing directional controls.

19. The electronic device of claim 17, wherein the red-eye-correction user interface logic is configured to update which candidate red-eye regions are visibly marked in accordance with the threshold as the threshold is adjusted.

20. The electronic device of claim 19, wherein the red-eye-correction user interface logic is configured to mark visibly at least one additional candidate red-eye region, when the threshold adjustment control is actuated in a first sense, and to mark visibly at least one fewer candidate red-eye region, when the threshold adjustment control is actuated in a second sense opposite the first sense.

21. The electronic device of claim 19, further comprising:
red-eye correction logic to perform red-eye correction in each visibly marked candidate red-eye region.

22. The electronic device of claim 19, further comprising:
a status control with which the user may indicate either one of rejection and acceptance; and
wherein the red-eye-correction user interface logic is further configured to
select and distinguish visibly from the other visibly marked candidate red-eye regions a lowest-confidence candidate red-eye region, the lowest-confidence candidate red-eye region having a least favorable figure of merit among the visibly marked candidate red-eye regions;
disqualify the lowest-confidence candidate red-eye region as a candidate red-eye region, when the user indicates rejection using the status control; and
requalify the lowest-confidence candidate red-eye region as a candidate red-eye region when, subsequent to disqualification of the lowest-confidence candidate red-eye region, the user indicates acceptance using the status control.

23. The electronic device of claim 22, wherein the status control comprises a pair of opposing directional controls.

24. The electronic device of claim 22, wherein the red-eye-correction user interface logic is further configured to indicate visibly that the lowest-confidence candidate red-eye region has been disqualified as a candidate red-eye region.

25. The electronic device of claim 22, further comprising:
red-eye correction logic to perform red-eye correction in each visibly marked candidate red-eye region that has not been disqualified.

26. The electronic device of claim 19, further comprising:
a navigational control to navigate to and select a particular visibly marked candidate red-eye region;
a status control with which the user may indicate either one of rejection and acceptance; and
wherein the red-eye-correction user interface logic is further configured to
disqualify the particular visibly marked candidate red-eye region as a candidate red-eye region, when the user indicates rejection using the status control; and
requalify the particular visibly marked candidate red-eye region as a candidate red-eye region, when the user indicates acceptance using the status control subsequent to disqualification of the particular visibly marked candidate red-eye region.

27. The electronic device of claim 26, wherein the navigational control comprises a pair of opposing directional controls.

28. The electronic device of claim 26, further comprising:
red-eye correction logic to perform red-eye correction in each visibly marked candidate red-eye region that has not been disqualified.

29. The electronic device of claim 17, wherein the electronic device is one of a desktop computer, a notebook computer, a PDA, a digital camera, and a radiotelephone.

30. An electronic device, comprising:
means for storing a digital image;
means for displaying the digital image;
means for identifying automatically at least one candidate red-eye region in the digital image, the means for identifying automatically at least one candidate red-eye region in the digital image being configured to assign a confidence score to each candidate red-eye region;
means for marking visibly for a user the candidate red-eye regions whose confidence scores exceed a threshold, the threshold having a predetermined initial value; and
means for adjusting the threshold in response to input from a user.
